(19) United States
(12) Patent Application Publication
(10) Pub. No.: US 2011/0138377 A1
(43) Pub. Date: Jun. 9, 2011

(54) Renewable Energy Monitoring System & Method

(75) Inventor: Marc Allen, Pasadena, CA (US)

(73) Assignee: PHAT ENERGY CORPORATION, La Crescenta, CA (US)

(21) Appl. No.: 12/773,740

(22) Filed: May 4, 2010

(51) Int. Cl. G06F 9/44

(52) U.S. Cl. 717/173

(57) ABSTRACT

A method and system that is capable of remotely managing processes of a renewable energy monitoring system through the internet. The system is capable of automatic detection and installation of firmware upgrades in renewable energy monitoring device where installed firmware components are dependent on peripheral configuration dataset and there are potentially a large number of peripheral configuration combinations. The system is also capable of processing data received from external instruments such as pyranometers, thermal sensors, or anemometers on a remote server by storing the peripheral configuration dataset of the renewable energy monitoring system in the remote server's database as well as data on how to process data from a wide range of instruments.

### TECHNICAL FIELD

This disclosure relates generally to internet connected renewable energy monitoring systems and methods that collect, monitor, and aggregate data from a renewable energy installation site to a remote web server. More particularly, this invention relates to an internet connected renewable energy monitoring system and methods that collect, monitor, and aggregate data from a renewable energy installation site and are capable of server based data processing, remote setup, and server selected firmware installation.

### BACKGROUND

There has been a rapid rise in interest, supply, and deployment of both commercial and residential renewable energy systems. Interest in renewable energy systems has been driven in part by concerns about global warming and carbon dioxide accumulation in the atmosphere, higher utility costs, as well as local, state, and federal tax incentives.

Renewable energy systems include solar photovoltaic, solar thermal, wind turbine, and geothermal electrical generating systems. The renewable energy systems referred to in this disclosure generate electricity that is connected to power inverters for the purpose of creating a stable AC voltage typically for supplying residential or commercial power needs and are often used in co-generation systems that share power with the commercial utility power grid.

With the increased deployment of these types of renewable energy power systems comes the need for accurate remote renewable energy system monitoring for both end users and system installers. One solution is to provide a network enabled renewable energy monitoring device that logs data from various systems components including power inverters, ambient temperature sensors, anemometers, pyranometers, and other sensors. This data stream from the network enabled renewable energy monitoring can be transmitted to a web server for remote monitoring.

It is often desirable to monitor energy generation from each power inverter within a renewable energy installation site. In order to facilitate this, power inverter manufacturers are providing various solutions for communicating information including voltage, current, instantaneous and cumulative power. One of the preferred communication standards is RS-485 (EIA-485). RS-485 is a point-to-point, multi-drop, twisted pair serial communication standard that allows, according to one specification, for the connection of up to 32 devices over a distance of up to 1200 meters.

One of the problems faced by system installers is that each power inverter manufacturer potentially has their own data transmission protocol, with some supporting custom inverter parameters and diagnostics. One solution developed by power inverter manufacturers is to design and manufacture their own proprietary renewable energy monitoring device. However, these systems suffer the disadvantage of being less flexible in situations where the customer or installer has a preferred monitoring system provider other than the inverter manufacturer or for established renewable energy installation sites where inverters of other manufacturers are already installed.

Another attempt to solve this problem is to provide a renewable energy monitoring device capable of communicating with a plurality of power inverter communication protocols. One of the challenges of this approach is that it leads to complex system firmware that may strain system resources and require a more complex and more expensive microcontroller. Firmware updates for these devices require the installer to visit the renewable energy installation site, which is often not desirable.

An additional challenge for renewable energy system installers is the monitoring and calibration of other instruments including ambient temperature sensors, anemometers, power meters, and pyranometers. These devices typically output an analog signal such as a DC voltage. A renewable energy monitoring device typically receives the analog signal from these devices into internal analog to digital converters. Each device type and model has their own unique set of characteristic parameters and calibration factor. A renewable energy monitoring device capable of processing signals from a several instruments types for a wide range of instrument models internally would require complex firmware and processing power. As in the case of a renewable energy monitoring device capable of communicating with a plurality of power inverter communication protocols, the firmware code base is more complex tends to require more frequent updates.

For the forgoing reasons, there is a need for a renewable energy monitoring system capable of communicating with a plurality of power inverter communication protocols and capable of processing signals from a range of models of analog instruments. In addition there is a need for a renewable energy monitoring device with modest processing capability and the capability to accept remotely configurable firmware updates that do not require the installer to visit the renewable energy installation site.

### SUMMARY

The present invention is directed to a device and process that satisfies the need of providing a renewable energy monitoring system capable of communicating with a plurality of power inverter communication protocols and capable of processing signals from a range of models of analog instruments that includes a renewable energy monitoring device with modest processing capability and firmware updates that do not require the installer to visit the renewable energy installation site. At the heart of this invention is the discovery that both automatic firmware upgrades of a renewable energy monitoring device and remotely processing external data from instruments connected to the renewable energy monitoring device may be facilitated by as follows.

Firmware binaries can be assembled from base code necessary to perform basic operations of the renewable energy monitoring device and from firmware components. Each firmware component contains software procedures sufficient for the renewable energy monitoring device to communicate with and, depending on the device, process information from a specific peripherally connected device. For example, firmware component A would enable the renewable energy monitoring device to communicate with RS-485 connected inverter A of a specific make and model, firmware component B would enable the renewable energy monitoring device to communicate with RS-485 connected inverter B of another make and model. The firmware binaries and a data record that contains a listing of the firmware components included in the firmware binary are stored in the remote internet connected server. The remote internet connect network server also stores the renewable energy monitoring device's hardware configuration information. This hardware configuration includes a listing of the peripheral device make and models connected to the renewable energy monitoring device. This hardware configuration can be entered manually into the remote internet connected server by a renewable energy system installer or by a factory technician using a remote internet connected user device such as a personal computer or a mobile device. When the server is prompted to update the firmware, it compares it's most correct record for the renewable energy device's hardware configuration, and selects the proper version of a firmware binary that contains all of the firmware components required to communicate with the peripheral devices listed in that hardware configuration. Subsequently, the firmware binary is uploaded to the renewable energy monitoring device. The renewable energy monitoring device performs a file integrity check, installs the firmware and reboots itself.

The entire firmware update process is done without manual intervention and can be initiated by either an event triggered by the remote internet connected server or by the renewable energy monitoring device. Example events triggering a renewable energy monitoring device firmware update include “powering on” the renewable energy monitoring device or a periodic timed request. The remote internet connected server can trigger a software update without intervention from the renewable energy monitoring device whenever it detects a change in its stored hardware configuration information for the renewable energy monitoring device.

The renewable energy monitoring device can include the capability of receiving signals from analog instruments through analog to digital converters and communicate the unprocessed instrument data to the remote internet connected server. The remote internet connected server has the capability to receive and store this data. In addition, the remote internet connected server stores a calibration dataset that includes device parameters and calibration data for each analog peripheral instrument. This may be either linked to or included in the peripheral configuration dataset. Both the calibration data and the device parameters can be entered manually into the remote internet connected server by a renewable energy system installer or by a factory technician using the remote internet connected user device such as a personal computer or a mobile device. The remote internet connected server has the capability to communicate a processed form of the instrument data to the remote internet connected user device, for example, a computer with a web browser. The remote internet server automatically processes the unprocessed instrument data by identifying the instrument that produced the unprocessed instrument data, retrieving the latest hardware configuration for the renewable energy monitoring device, finding the calibration dataset associated with that instrument, and applying it to the unprocessed data. The resulting processed data might be displayed in tabular form, or as a graph on a web page.

### DRAWINGS

These and other features, aspects, and advantages of the present invention will become better understood with regard to the following description, appended claims, and accompanying drawings where:

FIG. 1 shows a system diagram representation of a typical renewable energy monitoring system using solar photovoltaic panels as the electrical generating source.

FIG. 2 shows a block diagram representation of a renewable energy monitor device of FIG. 1 according to one embodiment of this disclosure.

FIG. 3 shows a representation of computer monitor display of web page served to a client computer showing system status and energy generation.

FIG. 4 shows a system diagram representation of a typical renewable energy monitoring system showing the connection of analog instruments.

FIG. 5 shows a representation of a computer monitor display of a web page served to an installer for entering externally connected hardware configuration information.

FIG. 6 shows a flow chart illustrating a procedure that may be used for receiving and storing externally connected hardware configuration information in conjunction with the embodiment of FIG. 5.

FIG. 7 shows a flow chart illustrating a procedure for installation of firmware for newly connected power inverters according to an embodiment of this disclosure.

FIG. 8 shows a flow chart illustrating a procedure for updating and installing firmware in a renewable energy monitor device of FIG. 1 according to one embodiment of this disclosure.

FIG. 9 shows a flow chart illustrating a procedure for automatically updating firmware according to an embodiment of this disclosure.

FIG. 10 shows a flow chart illustrating a procedure for establishing and sending calibration data of analog instruments connected to the analog to digital converter inputs in a renewable energy monitor device of FIG. 1 according to one embodiment of this disclosure.

FIG. 11 shows a flow chart illustrating a procedure for receiving and processing data on the server from instruments connected to the analog to digital converter inputs of a renewable energy monitor device of FIG. 1 according to one embodiment of this disclosure.

FIG. 12 shows a flow chart illustrating a procedure for displaying data on a representation of computer monitor display of web page served to a client computer of FIG. 3 according to one embodiment of this disclosure.

FIG. 13 shows a database schema block diagram for one embodiment of this invention.

FIG. 13A shows a database schema detail view of FIG. 12 according to one embodiment of this invention.

FIG. 13B shows a database schema detail view of FIG. 12 according to one embodiment of this invention.

FIG. 13C shows a database schema detail view of FIG. 12 according to one embodiment of this invention.

### DESCRIPTION

### Definitions

The definitions that follow define the meaning of specific terminology as applied to this application.

Renewable energy system: A system that generates electricity from either one or a combination of renewable energy sources that include solar photovoltaic, solar thermal, wind turbine, or geothermal. The renewable energy systems referred to in this disclosure generate electricity that is connected to power inverters for the purpose of creating a stable AC voltage typically for supplying residential or commercial power needs and are often used in co-generation systems that share power with the commercial utility power grid.

Renewable energy monitoring system: A system that includes a device for monitoring and logging data from system components within a renewable energy system defined as a renewable energy monitoring device.

Renewable energy monitoring device: A device for monitoring and logging data from system components or peripheral devices within a renewable energy system. For the purpose this disclosure, a renewable energy monitoring device at minimum monitors data from power inverters through data communication from the inverter. This data communication can be RS-485 but may also be wireless communication such as 802.11.

Renewable energy installation site: The physical location where the renewable energy electrical generating devices, power inverters, and renewable energy monitoring device are located.

Remote: Not located physically at the renewable energy installation site.

Remote internet connected server: This is physical computing device or multiple physical computing devices, not located physically at the renewable energy installation site, configured to send, receive, and process data to and from the renewable energy monitoring device and remote internet connected user devices using an internet protocol. The remote internet connected server includes a web server to communicate with the renewable energy monitoring device and remote internet connected user devices through HTTP protocol. The remote internet connected server can also include a database. Both the database and web server may reside in one or separate physical computing devices.

Peripheral configuration dataset: A data record or collection of data records, stored in the remote internet connected server, and associated with a specific renewable energy monitoring device. The peripheral configuration dataset includes information that identifies each specific peripheral device connected to the renewable energy monitoring device.

Firmware component: A software module or process designed to facilitate communication between a specific peripheral device or family or peripheral devices and the renewable energy monitoring device. Depending on the peripheral device, this may be complex code used to facilitate complex bi-directional communication between the renewable energy monitoring device and the peripheral device, or it may be as simple as a set of calibration levels for an analog signal that is received by the ADC inputs. A component can also be a higher-level software process that might be responsible for telemetry collection or configuration management. A set of firmware components are combined with firmware base code to create a firmware binary suitable to operate the renewable energy monitoring device.

Peripheral device: A device located at the renewable energy installation site that measures a parameter of the renewable energy system. The peripheral device is external to but communicates with the renewable energy monitoring device. A peripheral device can include a power inverter connected through RS-485 to the renewable energy monitoring device. It can also include analog measurement instrument such as temperature sensors for measuring ambient temperature, anemometers for measuring wind speed, pyranometers for measuring solar energy output from the sun, or alarm sensors, to alert remote administrators of system problems or theft.

Power Inverter: A device that converts voltage and current from a renewable energy electrical generating device such as a solar photovoltaic panel or a wind power generator and converts it to stable AC voltage and current typically for supplying residential or commercial power needs and are often used in co-generation systems that share power with the commercial utility power grid. A power inverter for the purpose of this disclosure has some means of communicating data with a renewable energy monitoring device. This can include, for example, RS-485 communication, or wireless communication such as 802.11.

Remote internet connected user device: This refers to an internet connected device that can communicate to a web server through HTTP protocol such as a desktop or notebook computer, or a mobile phone.

Analog peripheral measurement instrument: An instrument, located at the renewable energy installation site that is capable of measuring either a system or environmental parameter of a renewable energy monitoring system and outputting an analog signal. Examples of a peripheral measurement instruments include temperature sensors for measuring ambient temperature, anemometers for measuring wind speed, pyranometers for measuring solar energy output from the sun, or alarm sensors, to alert remote administrators of system problems.

Calibration dataset: This refers to either a single data record or set of data records that include calibration information for a specific analog peripheral measurement instrument that is installed and associated with a specific renewable energy monitoring device. The calibration dataset may also include device parameters.

### DETAILED DESCRIPTION

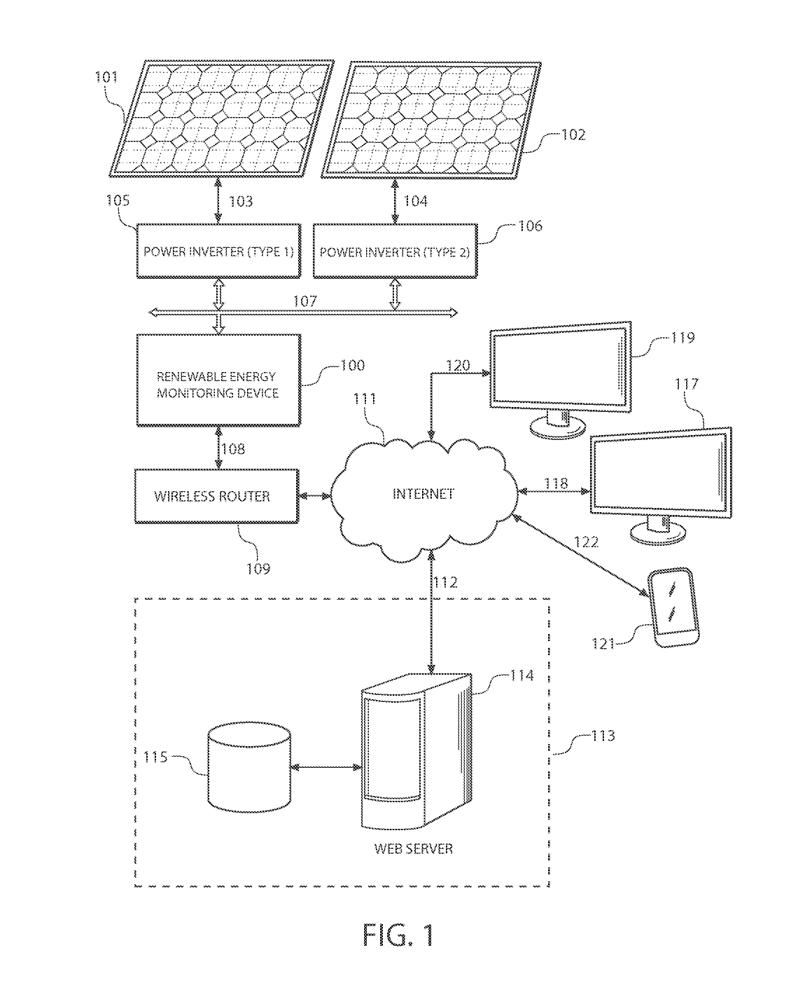

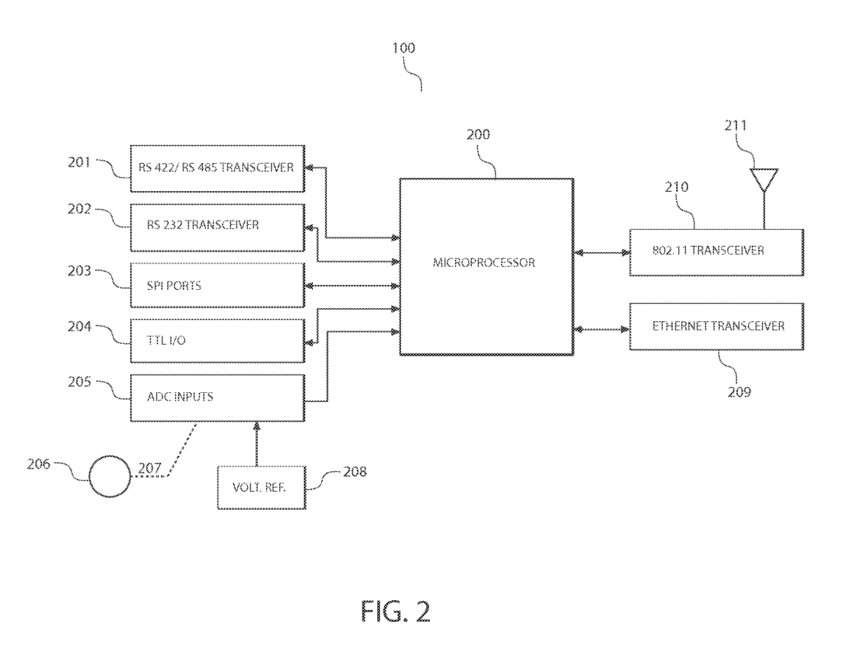

Referring now to the drawings in detail wherein like numerals indicate like elements throughout the several views, FIG. 1 an example of a typical renewable energy system, where one embodiment of the current invention incorporates a subset of components of the entire system. Referring to both FIG. 1 and FIG. 2, a renewable energy monitoring device 100 transmits data to and receives data from a first power inverter 105 and a second power inverter 106 through an internal RS-485 transceiver 201. These are connected together by a multi-drop twisted pair 107. In the illustrated embodiment of FIG. 1 each of first power inverter 105 and second power inverter 106 has its own power inverter communication protocol. These protocols can very widely from manufacturer to manufacturer. First power inverter 105 receives DC voltage and current from a first photovoltaic array 101 through a first power cable 103, and second power inverter 106 receives DC voltage and current from second photovoltaic array 102 through a second power cable 104.

Referring to FIG. 2, in addition to an RS-485 transceiver 201, the renewable energy monitoring device includes a microprocessor 200 capable of recognizing a plurality of power inverter communication protocols and connecting to, communicating with, sending, receiving, and processing data from first power inverter 105 and second power inverter 106 through the RS-485 transceiver 201. The microprocessor 200 receives its instructions from firmware. Means for storing the firmware capable of instructing the processor to connect to, communicate with, send, receive, and process data from the power inverters through one or more power inverter communication protocols as well as communicating with a web server through HTTP protocol can be accomplished by either internal reprogrammable non-volatile memory as in the embodiment of FIG. 2, or external non-volatile memory. Examples of non-volatile memory include FLASH memory, EEPROM, or MRAM.

Referring to FIG. 1 and FIG. 2, the renewable energy monitoring device 100 transmits data to and receives data from the internet 111 by way of an internet connected networking device, for example, an internet connected network router. In the embodiment of FIG. 1, and referring to FIG. 2, means for sending data to and receiving data from an internet connected networking device is 802.11 wireless transceiver 210. means for sending data to and receiving data from an internet connected networking device could be through either wireless transmitter and receiver complying with 802.11 standard such as 802.11b, 802.11g, or 802.11n or equivalent or through a mobile device 3G or 4G-protocol. It can also be through an Ethernet transceiver 209. Referring again to FIG. 2, the renewable energy monitoring device of that embodiment has both 802.11 wireless transceiver 210 with an antenna 211 and an Ethernet transceiver 209.

In the present embodiment, in addition to the RS-485 transceiver 201, the renewable energy monitoring device 100 has several I/O ports disposed to communicate with peripheral devices. These include general purpose TTL inputs/outputs 204, RS-232 transceiver 202, SPI ports 203, and analog to digital converter or ADC inputs 205. The ADCs are connected to voltage reference 208. One of the ADCs is connected directly to an internal temperature sensor 206 capable of measuring ambient temperature. The means for sending data to and receiving data from an internet connected networking device, in an embodiment, may optionally be used as an additional set of I/O ports. These may be utilized to send data to and receive data from network enabled power inverters or network enabled measurement instruments.

Referring back to FIG. 1, the renewable energy monitoring device 100 sends and receives data parsed from inputs such as first power inverter 105 and second power inverter 106 through an internet gateway 112 to a web server 114 that is a portion of the a remote internet connected network server 113. The remote internet connected network server 113 is capable of processing data from the renewable energy monitoring device 100 and storing it in a database 115. Both the database 115 and the web server 114 that are included in the remote internet connected network server 113 may reside in same physical computer or in separate network servers that together form the remote internet connected network server 113.

Customer computer 119, system installer or admin computer 117, or mobile network device 121 are all examples of remote internet connected user devices that may all monitor energy data logged by the renewable energy monitoring device 100 through a secure internet connection. In addition, a person with administrative privileges such as a system installer or factory technician may initiate new hardware installation or monitor systems from their entire customer base through their admin computer 117 or through a mobile networked device 121.

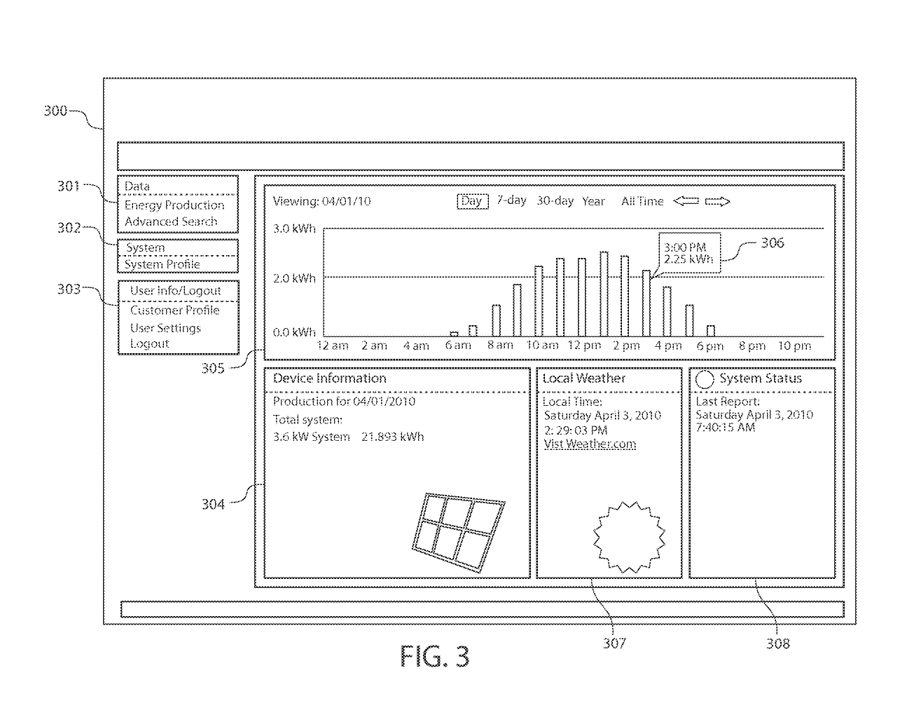

FIG. 3 shows an illustrative representation of computer monitor screen 300 on the customer computer 119 served by the web server 114. The left navigation menus that include the data sub-menu 301, system sub-menu 302, and user info sub-menu 303, allow the user to navigate through various data and options. The data sub-menu 301 gives the option of seeing the energy production output history of the system, which is the current screen view 305, or to search for a specific date range. The system sub-menu, 302 allows the user to view the system profile. The user info sub-menu 303, allows the user to update their customer profile, change their user settings or logout. The device information block 304 gives a summary of energy production. The web page also displays local weather 307 and system status 308. While in this embodiment the information was viewed on a customer computer 119, the system installer may similarly view the data on their admin computer 117.

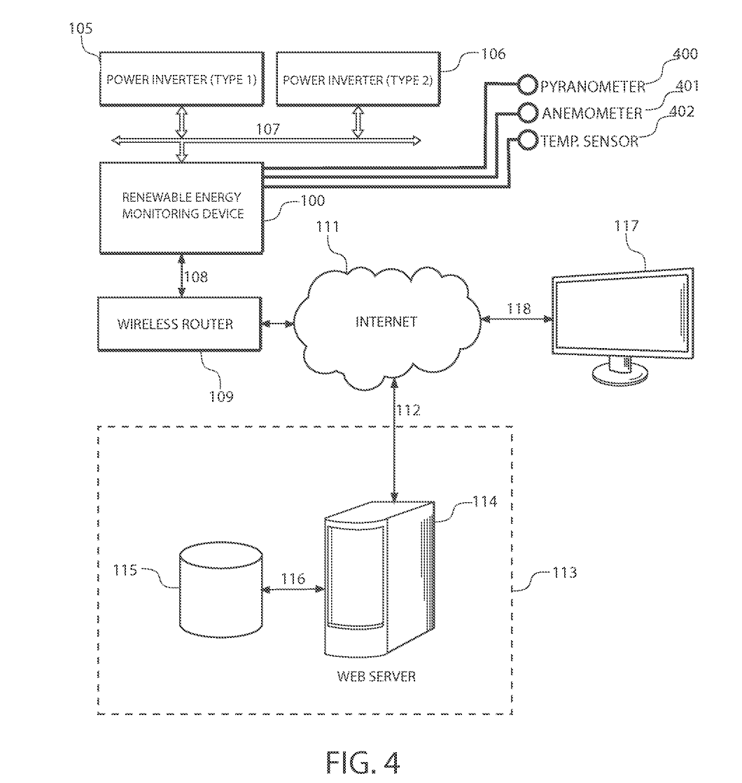

FIG. 4 represents a system diagram of a typical embodiment of the present invention during initial system installation. This diagram shows analog measurement instruments typically used in a renewable energy monitoring system. They include a pyranometer 400 for measuring solar radiation, an anemometer 401 for measuring wind speed, and a temperature sensor or thermometer 402 for measuring ambient temperature or other devices that output a similar analog signal.

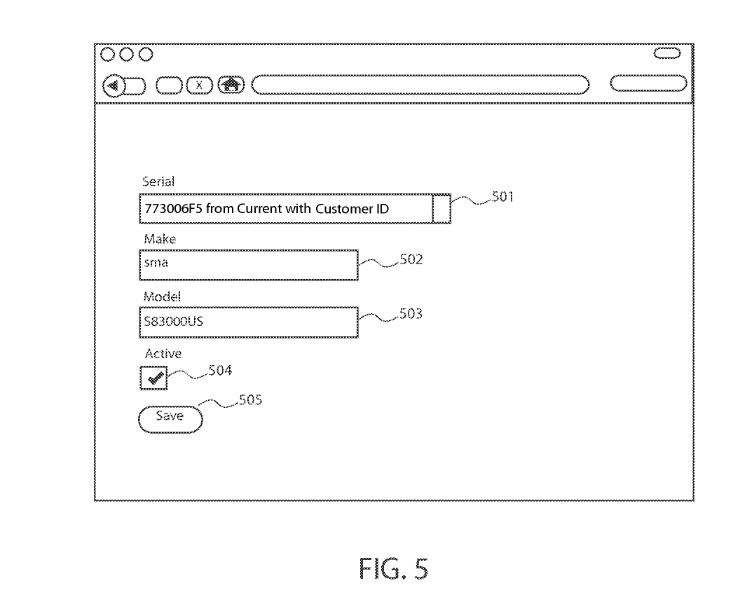

Typically, before the installation process begins at the renewable energy system installation site, in one embodiment of the present invention, the system installer would remotely log on to their administrative account on their admin computer 117 through a secure socket layer (SSL) internet connection. The system installer would manually enter what peripheral devices are connected the renewable energy monitoring device. This peripheral configuration dataset can include a plurality of power inverters, for example, the first power inverter 105 and second power inverter 106 in FIG. 1. The first power inverter 105 and second power inverter 106 may be the same or different make and models and may or may not share the same communication protocol. In one embodiment, the system installer may enter the peripheral configuration dataset on their admin computer 117 through a web browser page similar the representative illustration of FIG. 5. In this embodiment, the system installer enters the make 502 and model number 503 of the new device and selects the serial number from a pull down 501. They can choose whether or not the device is active or not 504 and “save the configuration” 505.

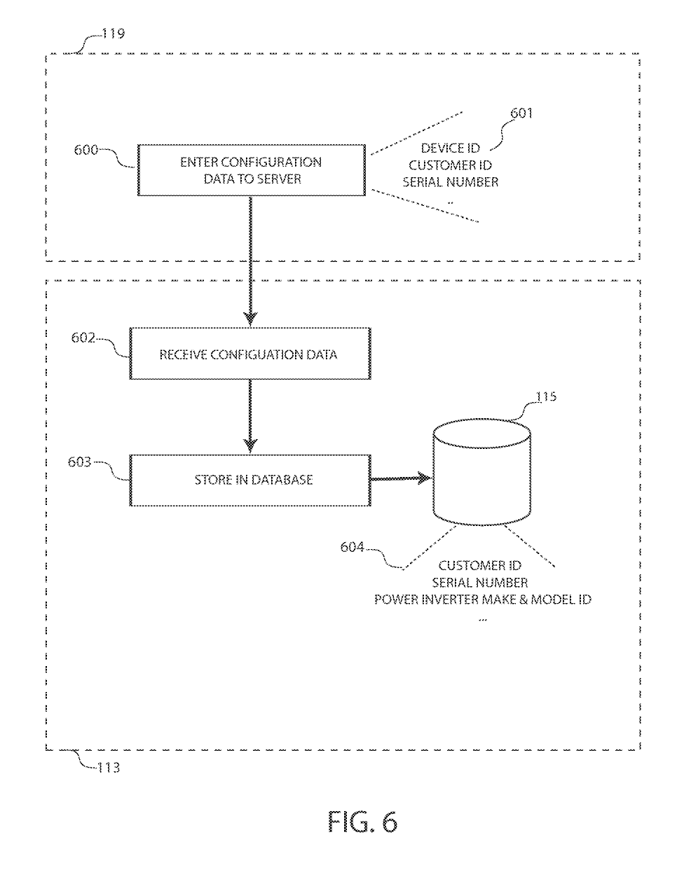

FIG. 6 is a flow diagram representing the process of entering and storing the peripheral configuration dataset in one embodiment from FIG. 5. The system installer “enters the configuration data” 600 as in a similar manner as described in the previous paragraph. The peripheral configuration data record 601 is sent to the remote internet connected network server 113. The remote internet connected network server 113 “receives the configuration data” 602, initiates “storing the information” 603 in the database 115. The peripheral configuration data record 601 is stored in a peripheral configuration dataset 604 in the database 115 and can later be used by the remote internet connected network server 113 for decision in firmware upgrades and processing external analog instruments.

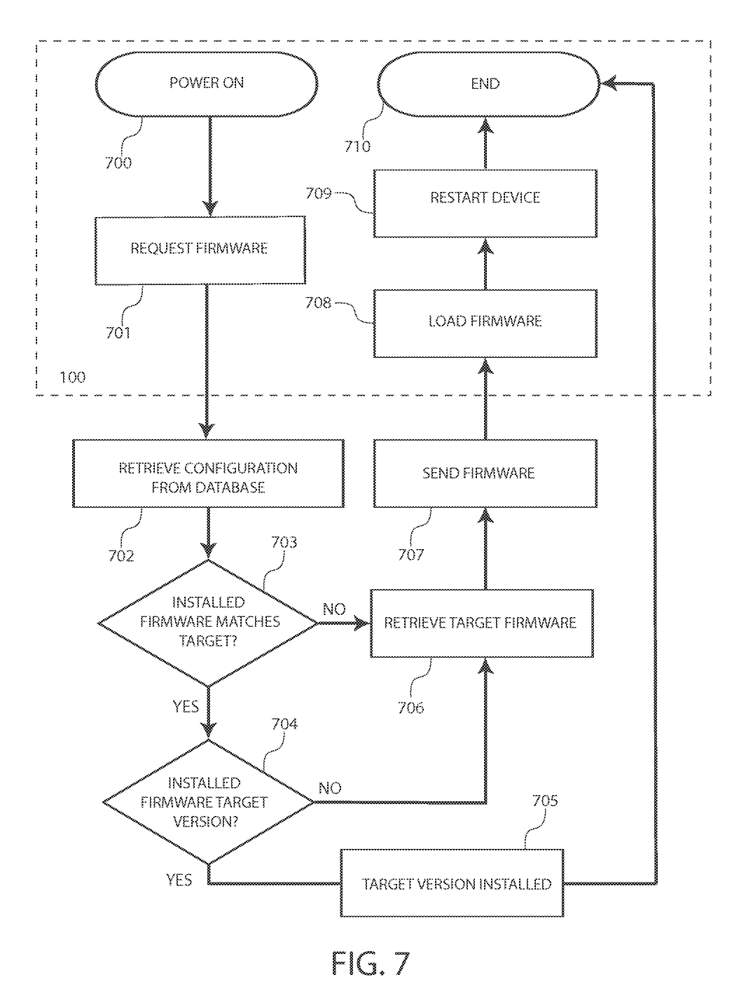

In one embodiment of the invention, the renewable energy monitoring device 100, is shipped from the factory with basic networking firmware. After the system installer has the hardware installation complete at the renewable energy installation site, they simply power on the renewable energy monitoring device. New firmware is installed in accordance with the flow diagram of FIG. 7 after the power-on sequence 700 is initiated.

Referring to FIG. 7, after power on 700, the renewable energy monitoring device makes a “request for new firmware” 701 from the web server 114. The request is made as an HTTP POST request to the web server 114. The non-volatile memory device that stores the firmware stores a configuration, in one embodiment, with the parameters taught by Table 1. Referring to both Table and FIG. 7, the HTTP string sent to web server 114 sends the Customer ID, Firmware Version, and the array that includes an ID of each firmware component installed and map directly to what hardware components are installed. In the present embodiment, the renewable energy monitoring device 100 would send a string that would include the component ID for the first power inverter 105 and second power inverter 106 from the embodiment of FIG. 1.

TABLE 1

| Configuration Parameters | Description |
|---|---|
| Renewable Energy Monitoring | Unique identifier for each renewable energy monitoring |
| Device ID | device |
| Customer ID | Unique identifier for each customer |
| Customer Key | Encryption key, unique to each customer |
| Server Host | Host name of renewable energy monitoring device server |
| Server Path | Path that the renewable energy monitoring device |
| | will load to commit transactions |
| Server Port | Port that the renewable energy monitoring device |
| | will use to commit transactions |
| Admin Password | Password used to log into the renewable energy monitoring |
| | device administrative terminal |
| WiFi Task Period | Period of the wifi maintenance task |
| WiFi SSID | SSID of the customer's wireless network |
| WiFi Encryption Type | Encryption type of the customer's wireless network |
| WiFi WEP Key Index | WEP encryption information |
| WiFi WEP Hex Key | WEP hex key |
| WiFi WPA Passphrase | WPA passphrase |
| ADC Task Period | Period of the ADC sampling task |
| ADC Samples | Number of samples to average per channel |
| Inverter Task Period | Period of the inverter monitoring task |
| Number of Inverters | Number of inverters to discover |
| Remote Update Task Period | Period of the remote update task |
| Firmware Version | Version of installed firmware (readonly) |
| Installed Components | Array of components installed (readonly) |

The web server 114 of the remote internet connected network server 113 receives the request and “retrieves the configuration data” 702 from the database 115. The current peripheral configuration dataset of the renewable energy monitoring device 100 stored in database 115 is compared 703 to the peripheral configuration data record for the renewable energy monitoring device 100 that was entered into the database 115 by the system installer in the previous step. If the installed firmware components does not match the list of firmware components the database 115 shows are required, then the remote internet connected network server 113 is instructed to “retrieve the target version of firmware” 706 that contains all of the correct components built on the target code base or version. If the installed components do match, the remote internet connected network server 113 checks if the installed firmware version is the target firmware version. If the installed version is the target version no firmware is sent or installed. If the installed version is not the target version remote internet connected network server 113 is instructed to “retrieve the target version of firmware” 706 that contains all of the correct components built on the target code version. The remote internet connected network server 113 will be encrypt the firmware's binary file and “send the firmware” 707 to the renewable energy monitoring device 100. As a next step the renewable energy monitoring device 100, “loads the firmware” 708 and automatically restarts itself 710. If this were first power-up after an installation, all the system installer would have to do is power up the unit and the firmware version with the correct components would be automatically installed.

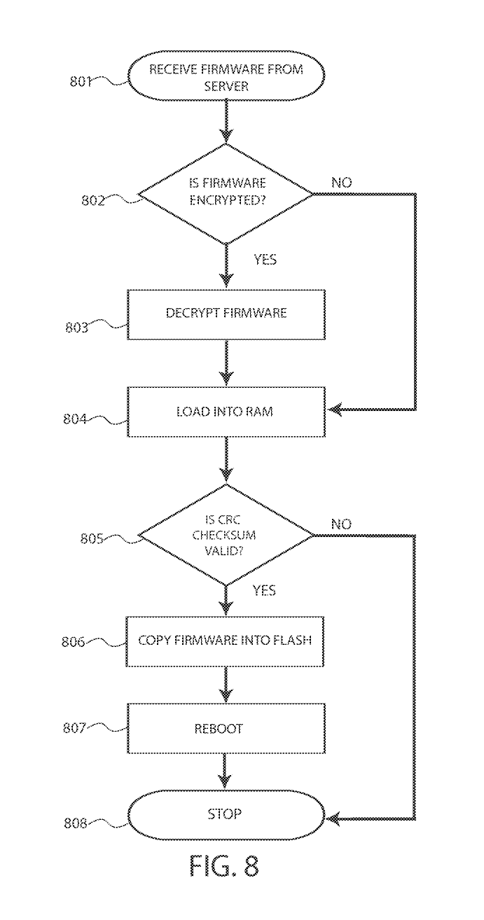

To illustrate the firmware install sequence in more detail, referring to FIG. 8, once the renewable energy monitoring device 100 “receives the firmware” 801 from the web server 114, renewable energy monitoring device checks to see if the firmware is encrypted 802. If it is not the firmware is loaded into RAM 804. If the firmware is encrypted, then it is decrypted 802 and then loaded into RAM 804. The CRC checksum is validated 805. If the checksum is valid, the firmware is copied into non-volatile memory 806, in this embodiment flash memory. The renewable energy monitoring device 100, rebooted automatically 807. If the checksum is not valid the firmware is not loaded and the routine ends 808.

The renewable energy monitoring device is capable of automatically installing new firmware either after a software version update or after a new peripheral configuration component is added and the component addition is recorded into the database by the system installer. The steps of recording a new peripheral configuration component into the database was described previous and in FIG. 6.

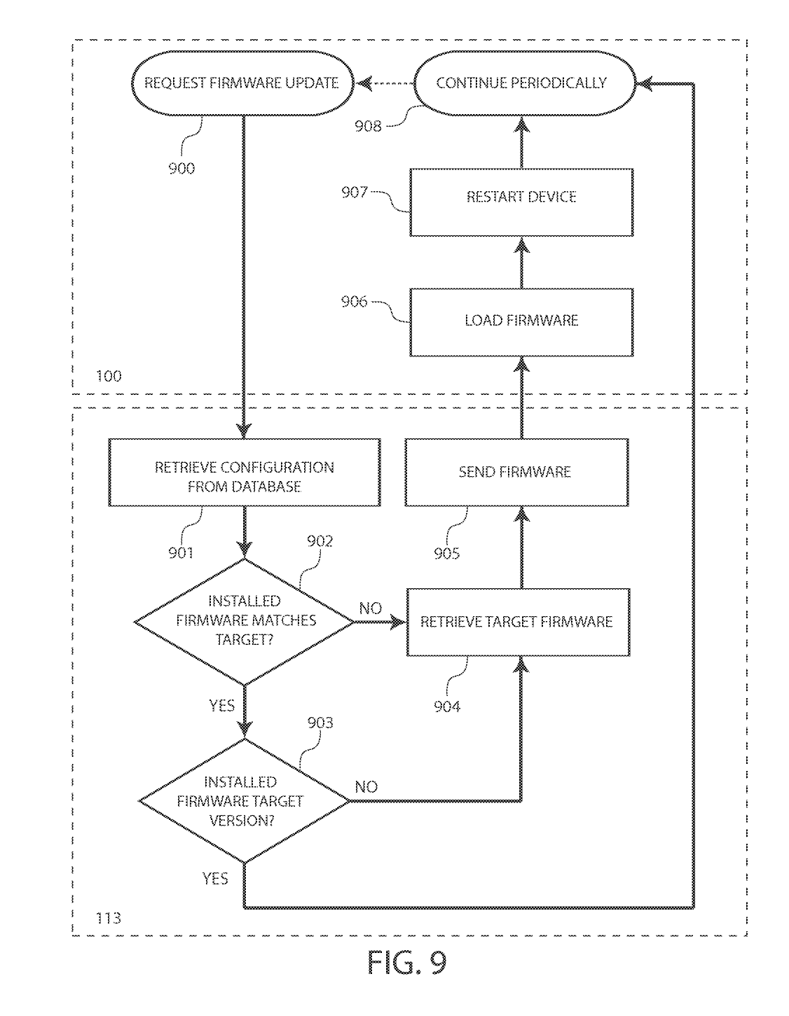

Referring to FIG. 9, the renewable energy monitoring device 100 polls the web server portion of the remote internet connected network server 113 at a configurable polling rate and requests a firmware update 900. It can be adjusted based on bandwidth and application domain. Typically, the polling rate is 120 seconds. However, other rates are possible ranging from every 30 seconds to as long an interval as desired. The remote internet connected network server 113 receives the request and “retrieves the configuration data” 901 from the database 115. The current configuration of the renewable energy monitoring device 100 is “compared to the configuration” 902 for that renewable energy monitoring device 100 that was entered into the database 115 by the system installer in the previous step. If the installed firmware components does not match the list of firmware components the database 115 shows are required, then the web server 114 is instructed to “retrieve the target version of firmware” 904 that contains all of the correct components built on the target code base or version. If the installed components do match, the web server 114 checks if the installed firmware version is the target version. If the installed version is the target version no firmware is sent or installed. If the installed version is not the target version the web server 114 is instructed to retrieve 904 the target version of firmware that contains all of the correct components built on the target code version. The web server 114 will encrypt the firmware's binary file and send it 905 to the renewable energy monitoring device 100. The renewable energy monitoring device 100 “loads the firmware” 906 and “automatically restarts itself” 807. The process pauses 908 until the next polling sequence.

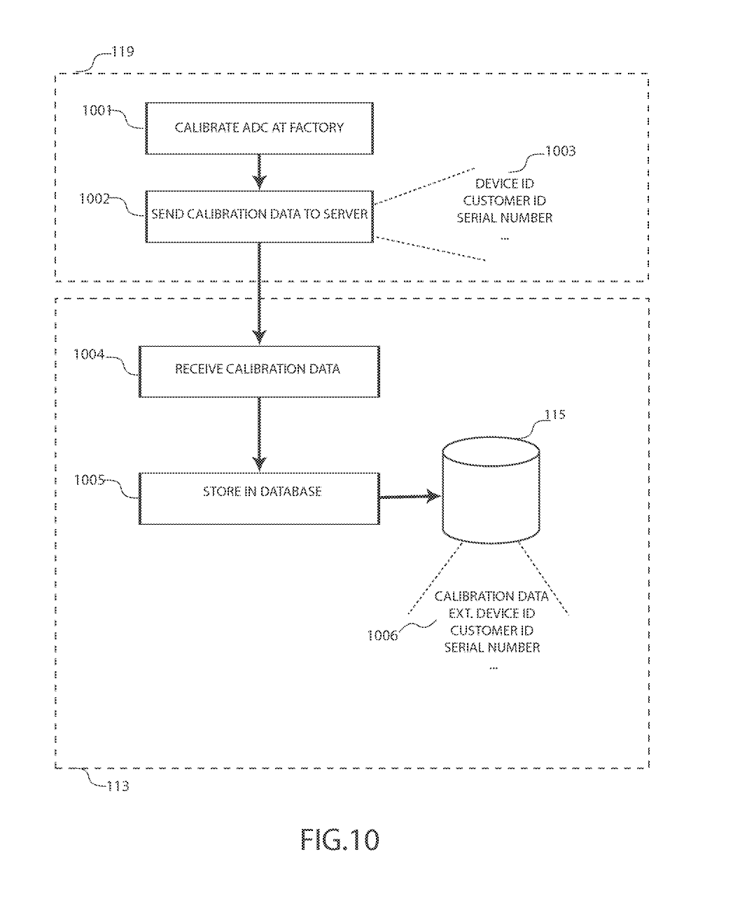

In an embodiment of the invention where analog instruments are to be connected to the ADC inputs 205 of the renewable energy monitoring device 100 if the devices are calibrated remotely such as at the factory or by the installer away from the installation site, the calibration data can be entered into the web server 114 on an admin computer 117 or any other remote internet connected user device with administrative privileges. Referring to FIG. 10, the ADC inputs 205 are calibrated at the factory 1001 in accordance to calibration factor required by the analog instrument. The factory technician logs into the administrative account through an admin computer 117. The calibration data is sent 1002 to the web server 114 along with the device ID, customer ID, and serial number 1003. The web server 114 “receives the calibration data” 1004 and stores it 1005 in the database 115. The database stores the calibration data and associates it with the external device ID, customer ID, and serial number 1006.

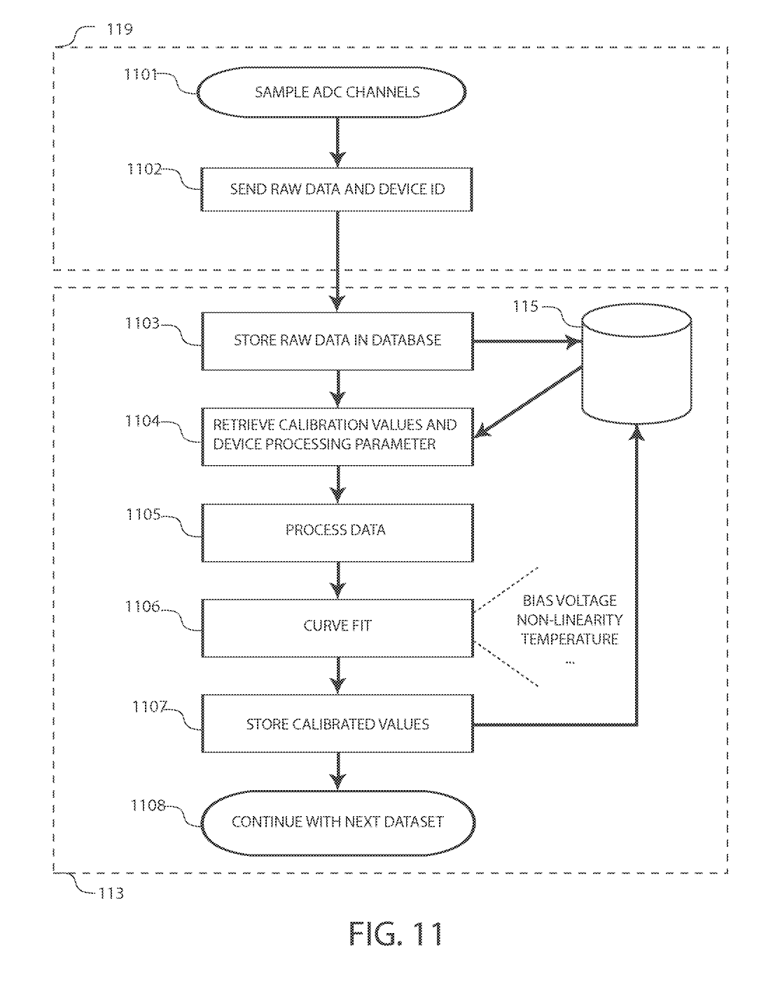

Referring to FIG. 11, FIG. 1 and FIG. 2, the renewable energy monitoring device's microprocessor 200, samples 1101 the ADC inputs 205. The renewable energy monitoring device “sends the raw data” 1102 and device ID to the web server 114 in the remote internet connected network server 113. The raw data is stored 1103 in the database 115. The remote internet connected network server 113 “retrieves calibration values and device processing parameters” 1104 and “processes the data” 1105 in accordance with these values and parameters. The “data is curve fit” 1106 for parameters, for example, bias voltage, non-linearity, and temperature. The temperature can be derived from the internal temperature sensor 206. The “calibration data is stored” 1107 in the database 115 and the next dataset is processed 1109.

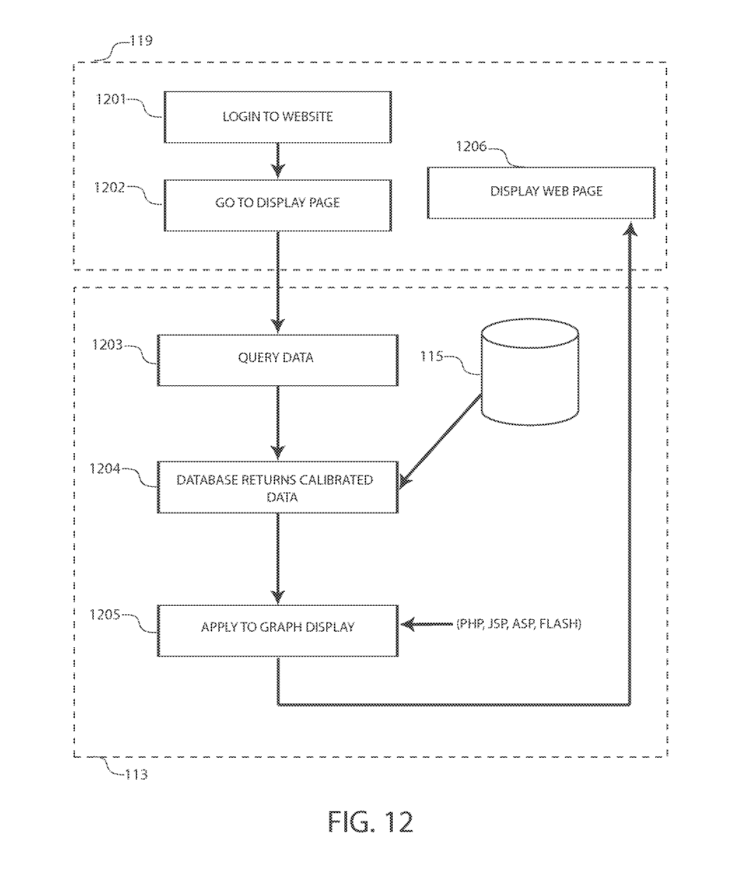

Referring to FIG. 12, the calibration data stored 1107 in the process illustrated in FIG. 11 is used anytime that data is later recalled. A system installer (person) logs into the administrative website using an admin computer 117. Next, the system installer makes a request 1202 to the web server 114 to access to a system status web page, refer to FIG. 3, for example. The web server 114 of the remote internet connected network server 113 queries 1203 the database 115. The database returns the calibrated data 1204. The calibrated data is applied to data that is this presented as a graph on the display 1205. The web server 114 in an embodiment uses a server side programming language such as PHP, JSP, ASP, or alternatively use FLASH to process the data into a graphical form. The outputted data is then displayed on a web page 1206.

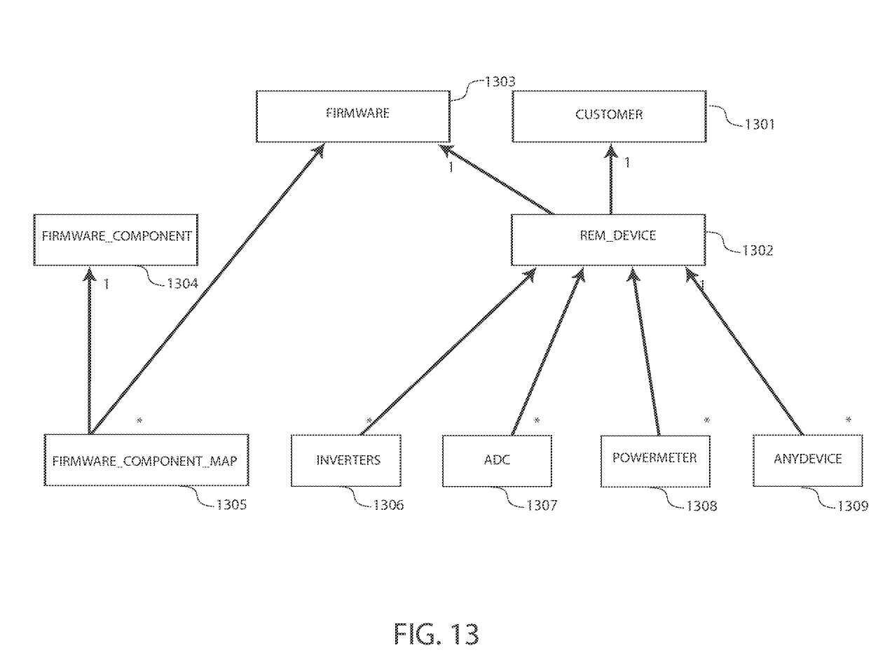

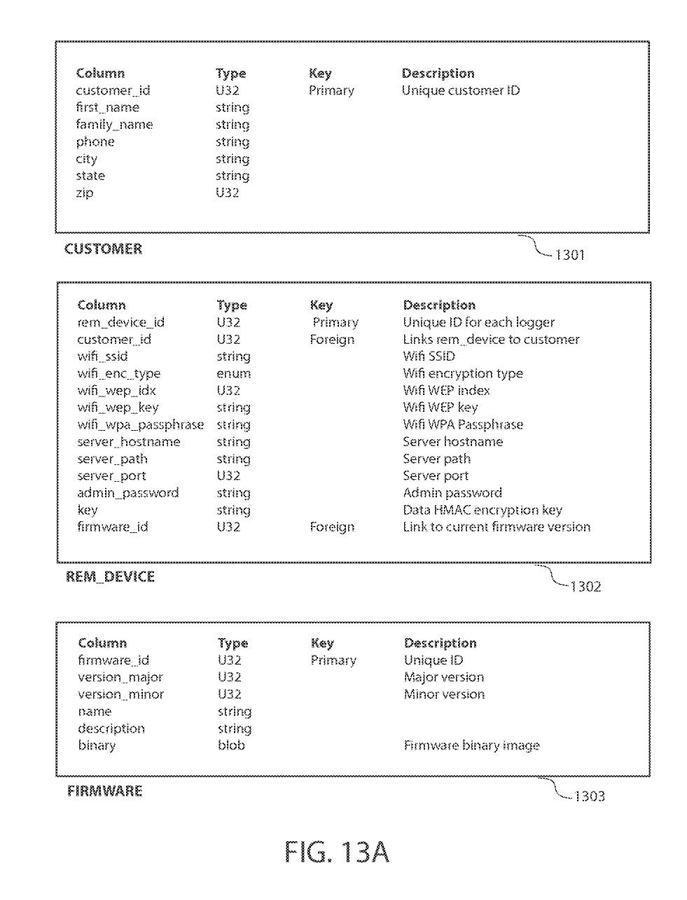

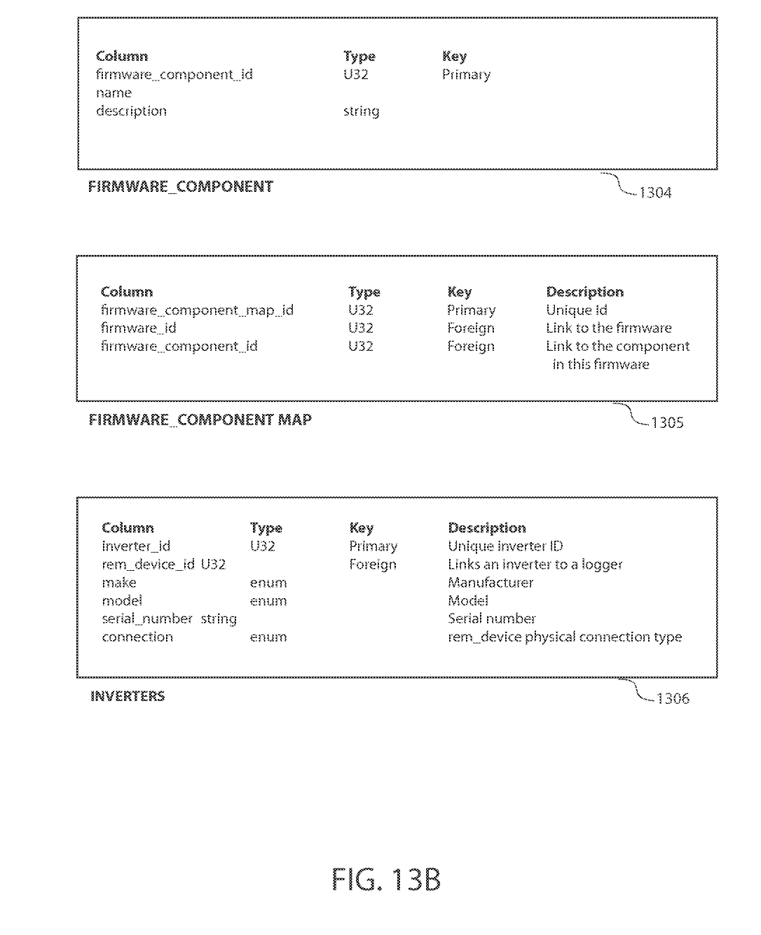

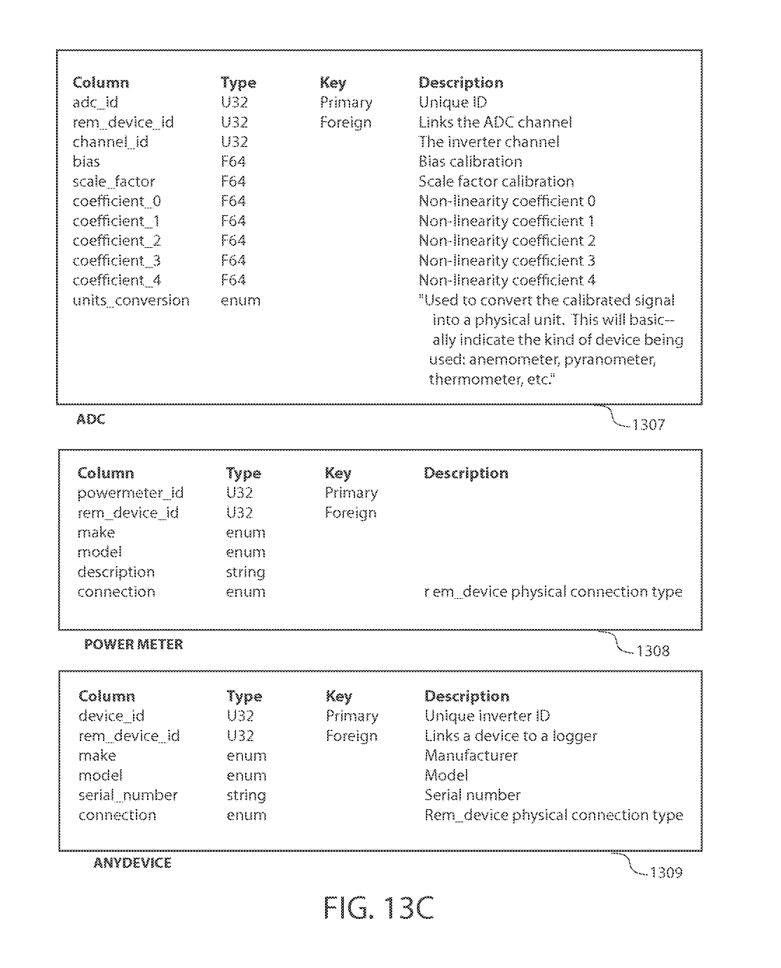

FIG. 13 is a database schema included in an embodiment of the invention. The diagram shows the relationships between the database tables. These tables include a customer table 1301, rem_device table 1302, firmware table 1303, firmware_component table 1304, firmware_component_map table 1305, inverters table 1306, ADC table 1307, powermeter table 1308, and anydevice table 1309. Referring to FIG. 13A, the customer table 1301 includes contact information for customers. The rem device table 1303 includes data for a particular renewable energy monitoring device 100 such as a unique device identifier or device id, server connection information, data encryption keys, and wifi connection information for connecting with an internet connected wireless networking device 109. In addition, the rem_device table 1302 links the renewable energy monitoring device 100 to current installed version of firmware though a foreign key to the firmware table. The firmware table includes a unique firmware id, version number, and the firmware binary code. There is a one to may relationship between the customer table 1301 and rem_device table 1302. In other words, each customer can have many renewable energy monitoring devices 100, but each renewable energy monitoring device 100 can belong to only one customer. Similarly, there is a one to many relationship between the firmware table 1303 and rem_device table 1302. Each version of firmware can be associated with many renewable energy monitoring devices 100, however each renewable energy monitoring device can only be associated with one version of firmware or one firmware table 1303.

Referring to FIG. 13B, the firmware_component table 1304 includes information that points to firmware components. The firmware_component_map table 1305 ties together the firmware table 1303 with individual firmware components. The firmware_component_map table 1305 determines what firmware components are included in a given firmware table 1303 record.

Referring to both FIGS. 13A, and 13B, the peripheral devices are broken down in the database by types. A first power inverter 105 is associated with a particular record in the inverter table 1306, an analog peripheral measurement instrument, such as a pyranometer 400 or an anemometer 401, as in FIG. 4, that communicates to the renewable energy monitoring device 100 through its ADC inputs 205, as in FIG. 2, each have their own record in the adc table 1307. Power meters have their own table, powermeters 1308, and peripheral devices not fitting into any of the other categories such as remote alarm devices each have their own record in their own tables that is analogous to the anydevice table 1309.

As an illustrative example of how this database schema would be used in an embodiment of the invention, referring to FIG. 4, the renewable energy monitoring device 100 has two power inverters, power inverter A 105, and power inverter B 106 connected and in communication with it through RS-485 communication 107. Referring again to FIGS. 13 through 13C, the hardware device configuration will include two records from the inverter table 1306 linked to the rem device table associated with renewable energy monitoring device 100. The rem_device table 1302 associates a particular version of firmware with firmware installed in the renewable energy monitoring device 100. The firmware_component_map table 1305 is used by the remote internet connected network server 113, to determine what firmware components are present in given firmware.

Referring back to FIG. 4, and to FIGS. 13 through 13C, if any anemometer 401 were added to the peripheral configuration dataset, the remote internet connected network server 113, in the present embodiment, would automatically query the records of firmware_component_map table 1305 to determine what firmware binary contained both the appropriate version and the components required for the renewable energy monitoring device 100 to communicate with power inverter A, power inverter B, and the anemometer 401.

A renewable energy system and method with the above mentioned objectives have been described. Those skilled in the art should appreciate that the invention is not intended to be limited to the preferred embodiments of the invention described within this disclosure. Various modifications will be apparent, particularly upon consideration of the teachings provided herein. Therefore, the invention should be understood to extend to the subject matter as defined in the following claims, and equivalents thereof.

What is claimed is:

1. A method for automatically updating firmware in a renewable energy monitoring device from a remote internet connected server, which comprises:
storing an peripheral configuration dataset in the remote internet connected server;
selecting a firmware binary that includes one or more firmware components, whereby the combination of the one or more firmware components enables communication within the renewable energy monitoring device with each peripheral device included within the peripheral configuration dataset;
uploading the firmware binary from the remote internet connected server to the renewable energy monitoring device; and
automatically installing and enabling the firmware binary in the renewable energy monitoring device as a result of uploading the firmware from the remote internet connected server to the renewable energy monitoring device.

2. A method of claim 1, which further comprises:
entering or modifying the peripheral configuration dataset from a remote internet connected user device whereby, the step of storing the peripheral configuration dataset in the remote internet connected server is a result of entering or modifying the peripheral configuration dataset.

3. A method of claim 2, which further comprises initiating a request for a firmware update by the remote internet connected server without initiation from the renewable energy monitoring device.

4. A method of claim 3, whereby the step of initiating the request for the firmware update by the remote internet connected server is a result of a change in the peripheral configuration dataset stored by the server.

5. A method of claim 1, which further comprises:
initiating a request for a firmware update from the renewable energy monitoring device to the remote internet connected server.

6. A method of claim 5, which further comprises:
powering on the renewable energy monitoring device whereby, the step of initiating the request for a firmware update from the renewable energy monitoring device results from the step of powering on the renewable energy monitoring device.

7. A method of claim 5, whereby initiating the request for firmware update occurs at a selected time period determined by the renewable energy monitoring device.

8. A method of claim 1, which further comprises:
initiating a request for a firmware update by the remote internet connected server without initiation from the renewable energy monitoring device.

9. A method of claim 8, whereby the step of initiating the request for a firmware update by the remote internet connected server is a result of a change in the peripheral configuration dataset stored by the server.

10. A internet connected renewable energy monitoring system capable of collecting, monitoring, and aggregating data from a renewable energy installation site to a remote web server, comprising:
(a) a renewable energy monitoring device, including:
(i) an RS-485 transceiver capable of transmitting and receiving data from one or more power inverters;
(ii) a microprocessor capable of connecting to, communicating with, and processing data from one or more peripheral devices including connecting to, communicating with, and processing data from the one or more power inverters through the RS-485 transceiver;
(iii) means for sending data to and receiving data from an internet connected networking device; and
(iv) means for storing firmware capable of instructing the processor to communicate using one or more power inverter communication protocols and for receiving a firmware binary from the internet connected networking device;
(b) a remote internet connected server, disposed to communicate with the renewable energy monitoring device, and containing procedures for acting on the renewable energy monitoring system configured for:
(i) processing, aggregating, and formatting power inverter data from the renewable energy monitoring device;
(ii) storing information about the renewable energy monitoring device including an peripheral configuration dataset, including a dataset including one or more peripheral configuration data records;
(iii) selecting a firmware binary, stored in remote internet connected server, that includes one or more firmware components, whereby the combination of the firmware components operatively functions to enable communication within the renewable energy monitoring device with each peripheral device included within the peripheral configuration dataset; and
(iv) uploading the firmware binary from the remote internet connected server to the renewable energy device; and
(c) the processor is disposed to automatically install and enable the firmware binary in the renewable energy monitoring device as a result of receiving the firmware binary from the remote internet connected server.

11. A system of claim 10, wherein the remote internet connected server includes means for communicating with an internet connected user device.

12. A system of claim 11, wherein the remote internet connected server procedures are further configured for receiving the one or more peripheral configuration data records from the internet connected user device.

13. A system of claim 11, further comprising means for receiving a signal from an analog peripheral measurement instrument connected to the renewable energy monitoring device.

14. A system of claim 13, wherein the remote internet connected server procedures are further configured for:
storing a calibration dataset including calibration information and device parameters for the analog peripheral measurement instrument;
selecting the calibration dataset based on information in the peripheral configuration dataset; and
processing the signal from the analog peripheral measurement instrument by applying calibration information and device parameters to the signal.

15. A system of claim 14 wherein the remote internet connected server receives the calibration dataset from the remote internet connected user device.

16. A system of claim 10, wherein means for sending data to and receiving data from an internet connected networking device is further disposed to send data to and receive data from one or more peripheral devices.

17. A system of claim 16, wherein means for sending data to and receiving data from an internet connected networking device is disposed to send and receive data from a network enabled power inverter.
